(19) United States
(12) Patent Application Publication
(10) Pub. No.: US 2022/0164786 A1
(43) Pub. Date: May 26, 2022

(54) MANAGING SECURE APP-LESS DISTRIBUTION OF CUSTOMIZED TRANSACTION CARDS TO ONLINE DIGITAL WALLETS WITH INSTANT APPS

(71) Applicant: OnDot Systems Inc., San Jose, CA (US)

(72) Inventors: Aurovinda K. Gangam, Pleasanton, CA (US); Manikandan Periyasamy, Dunwoody, GA (US)

(21) Appl. No.: 17/100,909

(22) Filed: Nov. 22, 2020

(51) Int. Cl. G06Q 20/36; G06F 8/60; G06F 8/35; G06Q 20/32

(52) U.S. Cl. CPC G06Q 20/36; G06F 8/60; G06Q 20/3255; G06Q 20/326; G06F 8/35

(57) ABSTRACT

Customized instant apps are generated for transaction cards based on at least sender information, receiver information, and transaction information. The instant apps are executed by an operating system without previous installation by the operating system and are discarded after execution. A receiver device executes the transaction card instant app in order to transfer the transaction card to an online digital wallet. This process can be completed without burdening users to sign into online digital wallet systems to manually transfer transaction cards.

### FIELD OF THE INVENTION

The invention relates generally, to computer networking security, and more specifically, to managing secure app-less distribution of customized transaction cards to online digital wallets with instant apps.

### BACKGROUND

Digital wallets allow fast mobile payments for secure electronic transactions between parties over the Internet. The parties can be remote from each other, or face-to-face. Credentials can be passed over near field communication (NFC) as a user waves a mobile device over a checkout terminal, or by QR code, for example. The wallet system automatically contacts the card networks to get a token and then saves the token securely on the mobile device.

The conventional paradigm of adding cards to digital wallets typically involves searching for an app on an app store and installing apps to manage the transfer. These steps although they may take just a few minutes, are burdensome to mobile users and is in fact too complicate for some.

What is needed is a robust technique for managing secure app-less distribution of customized transaction cards to online digital wallets with instant apps.

### SUMMARY

To address the above-mentioned shortcomings, methods, computer-readable mediums, and devices are provided for managing secure distribution of customized transaction cards to online digital wallets with instant apps.

In an embodiment, a transmission of data packets is received, comprising a request from a sender device to send a transaction card to a receiver device. A customized instant app is generated for the transaction card based on at least sender information, receiver information, and transaction information, wherein the instant app is executed by an operating system without previous installation by the operating system.

In another embodiment, the transaction card instant app is sent to the receiver device (e.g., by Google Play Store or Apple Store), wherein the receiver device executes the transaction card instant app in order to transfer the transaction card to an online digital wallet.

In still another embodiment, a request to validate the transaction card from the online wallet is received. Responsive to validating the transaction card, an approval response is sent. The online digital wallet confirms the transfer of the transaction card. The transaction card is deactivated at the transaction card management server.

Advantageously, computer performance is improved by eliminating the burden of installing apps for managing digital wallets. Moreover, user ease and experience are improved.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for managing secure app-less distribution of customized transaction cards to online digital wallets with instant apps, according to an embodiment.

FIG. 2 is a more detailed block diagram illustrating a transaction card management server of the system of FIG. 1, according to some embodiments.

FIG. 3A is a sequence diagram illustrating a flow of a transaction card screenshots for iOS-based devices, according to an embodiment.

FIG. 3B is a sequence diagram illustrating a flow of a transaction card screenshots for Android-based devices, according to an embodiment.

FIG. 4 is a high-level flow diagram illustrating a method for managing secure app-less distribution of customized transaction cards to online digital wallets with instant apps, according to an embodiment.

FIG. 5 is a more detailed flow diagram illustrating a step of generating, by a processor of the transaction card server, a customized instant app for the transaction card from the method of FIG. 5, according to an embodiment.

FIG. 6 is a more detailed flow diagram illustrating a step of generating the customized instant app from the method of FIG. 5, according to an embodiment.

FIG. 7 is a block diagram illustrating an example computing device, according to one embodiment.

### DETAILED DESCRIPTION

Systems with computer hardware devices, computer-implemented methods, and (non-transitory) computer-readable mediums, for managing secure app-less distribution of customized transaction cards to online digital wallets with instant apps, are disclosed.

One of ordinary skill in the art will recognize many possible variations that are not explicitly described herein for the purpose of conciseness. For example, instant apps have been describe herein as mechanism for transferring transaction cards, but any appropriate mechanism can be substituted.

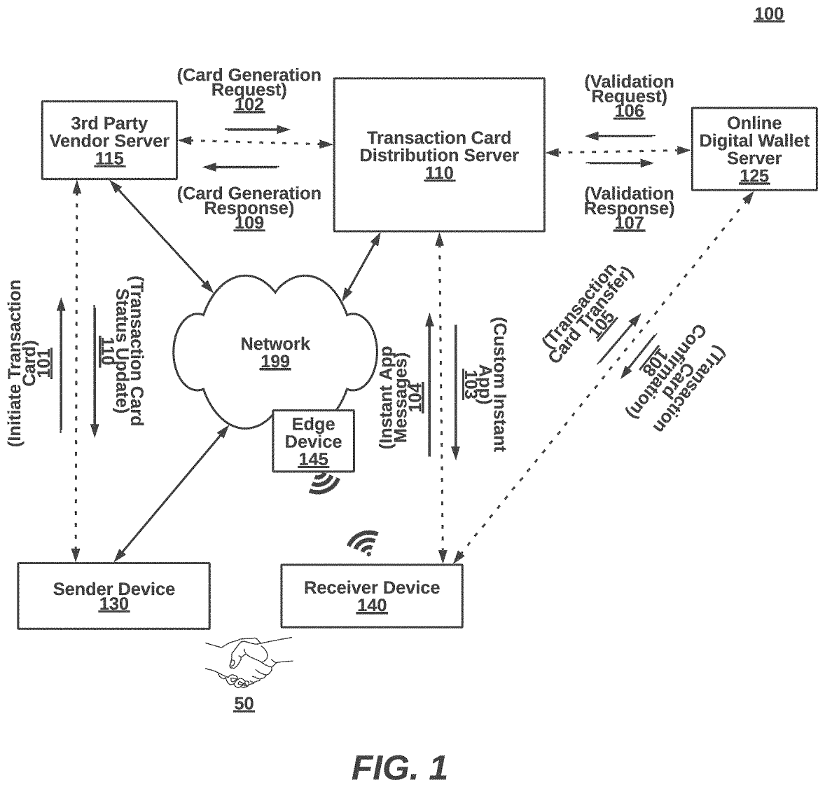

### I. System for App-Less Distribution of Transaction Cards (FIGS. 1-3)

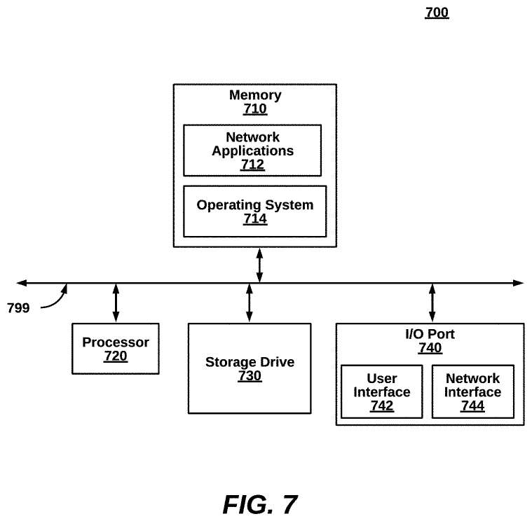

FIG. 1 is a high-level block diagram illustrating a system 100 for managing secure app-less distribution of customized transaction cards to online digital wallets with instant apps, according to an embodiment. The system 100 primarily comprises a transaction card management server 110, a 3rd party vendor server 115, an online digital wallet server 125, a sending device 130, and a receiving device 140. Additional network components can also be part of the system 100, such as firewalls, virus scanners, routers, switches, application servers, databases, data lakes, data warehousing, as well as additional controllers, access points, access switches, stations, SDN (Software-Defined Networking) controllers, Wi-Fi controllers, and the like. The network components can be implemented as hardware, software, or a combination of both, for example, as described with respect to the computing environment of FIG. 7.

Each of the primary components are coupled in communication through a network 199, preferably through wired connections but connections can also be wireless. The sender device 140 may be a mobile device using Wi-Fi or cellular, for example, that couples to an edge device 145 for access to the network 199. The network 199 may be the Internet, a wide area network, a local area network, a cellular network (e.g., 3G, 4G, 5G or 6G), Wi-Fi, or a hybrid network.

The transaction card distribution server 110 generates customized instant apps for managing transaction distribution cards as they are sent from sender to receiver, and then from receiver to receiver online wallet. Alternatively, the sender and receiver can be the same party in the case when a card is added to a sender's own wallet. A transaction card, as referred to herein, can be a temporary card such as a merchant gift card or can be a permanent card such as a debit card. For example, a user can log directly to the transaction card distribution server 110 through a web browser and purchase a $100 cash gift card. In another example, a user can log on to Amazon.com and purchase a $100 Amazon gift card (e.g., 101) that outsources distribution to the transaction card distribution server 110 (e.g., 102). In one implementation, the outsourcing is a white label outsourcing in that Amazon branding can be added to a template for the custom app. In still another example, the transaction card distribution server 110 issues a private label card that is backed by Visa, MasterCard, or another underlying financial service. One instance of a transaction card is a derivative for a child from a master account card of a parent.

Instant apps handle registration of transaction cards with the online digital wallet 120. The term instant apps, as used herein, can refer to App Clips by Apple, Inc., Instant Apps by Google, Inc., or other operating systems. Vendors can also use operating system agnostic instant apps. Besides these platforms, instant apps can also refer to mini apps or chunks apps. To this end, a small app (e.g., 10 MB) can be downloaded and executed without installation to a computer system. Users can opt to download a more robust version of the app for installation if necessary for transfer or additional functions. Once instant apps have completed a task, function or purpose, they are terminated. The instant apps may be completed removed from the environment, or in some cases, a download log, execution record, or other remnants of particular instant apps and particular executions is stored for later analysis.

The transaction card distribution server 110, in one embodiment, manages the custom app transmission to a receiver device (e.g., 103) and validates the transaction card responsive to receipt at an online digital wallet (e.g., 105,106,107,108). The transaction card is deactivated at the transaction card distribution server if a onetime card, and the transaction card status is updated if a persistent card (e.g., 104,109). The status can be reported to a merchant (e.g., 110).

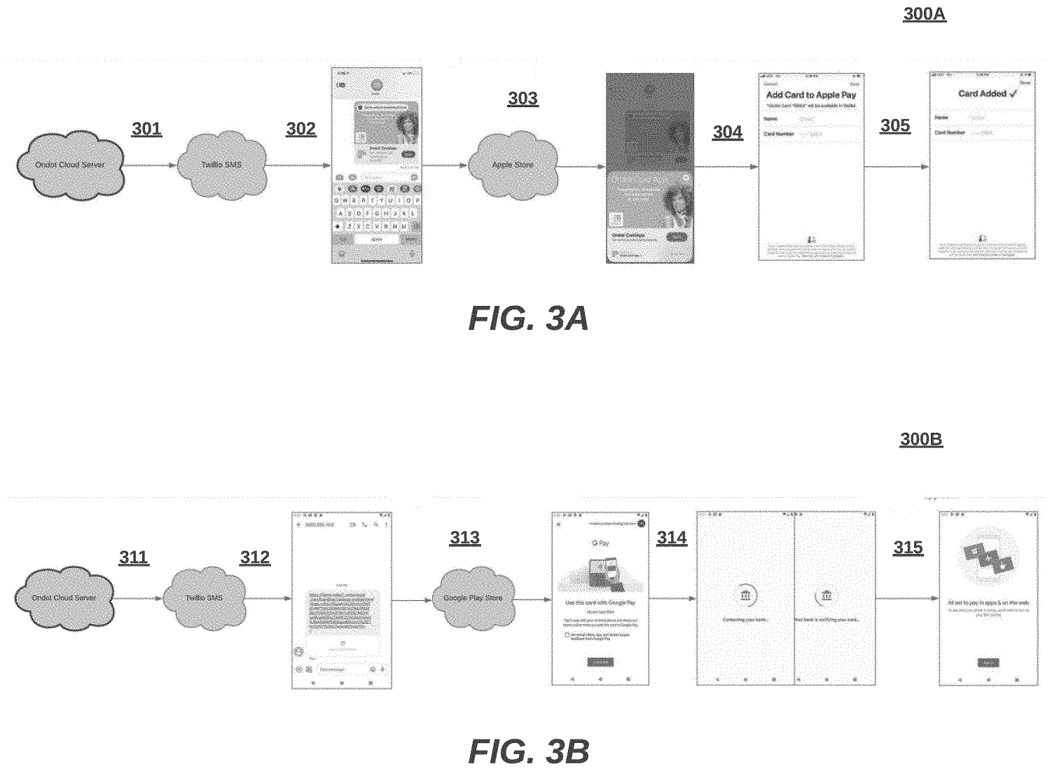

In one embodiment, the transaction card distribution server 110 comprises a processor-driven network device. The transaction card distribution server 110 can be a stand-alone device or be integrated into, for example, an application server with many other apps. The transaction card distribution server 110 can be controlled by a third-party that offers front-end card services to senders and back-end card services to vendors. Additional embodiments of the transaction card distribution server 110 are disclosed below with respect to FIG. 3.

The online digital wallet 120 stores the transaction card transferred by the instant app, along with other forms of payment associated with the receiver, for mobile payments. The transaction card can be verified by the transaction card distribution server 110 before being committed by the online digital wallet 120. In an embodiment, the online digital wallet 120 comprises Apple Wallet, Apple Passbook, Square Wallet, Google Wallet, Venmo PayPal, and stores Apple Pay cards, Google Pay cards, debit cards, credit cards, gift cards, merchant cards (e.g., Starbucks), crypto currency cards, and any appropriate digital payment form. Other example wallet assets that are non-financial can include tickets, credentials and IDs. Some embodiments of the “online” digital wallets, as referred to herein, can also apply to digital wallets that are not network connected or that are periodically connected online. Receivers can make purchase and other transactions with transaction cards at retail points of sale using NFC (e.g. to pay for coffee or to fill parking meter).

The sender device 130 initiates a transaction by purchasing transaction cards. In one case, a sender logs on to the transaction card distribution server 110 to purchase a gift card or to open a transaction card (or replace card, or update card). In a second case, a sender logs on to a merchant web site and purchases a gift card or opens a transaction card processed on the back end by the transaction card distribution server 110.

The receiver device 140 receives notification of the instant app or notification of the transaction. An implementation downloads the instant app to the receiver device 140 as an attachment on SMS messaging apps. An alternative implementation sends a download hyperlink for downloading. Downloads can be directly from the transaction card distribution server 110 or from third-party app providers, such as the Apple Store, Google Play, Chrome Store, Samsung Galaxy Apps, LG SmartWorld, Sony Apps, Amazon Appstore, and others. Either way, the instant app downloads and executes without permanent installation to an operating system of the receiver device 140. Permission can be requested to download and execute instant apps. The instant app executes temporarily until reboot or until the app is exited or closed. A transaction card embedded in the instant app can be presented to a receiver on the receiver device along with an option to add to a digital wallet. If approved, the instant app continues executing (or downloading) by locating the online digital wallet and submitting to a user account corresponding to the receiver. In some embodiments, the receiver device 140 comprises an NFC chip and supporting software for completing mobile transactions.

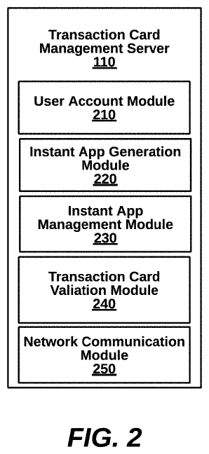

FIG. 2 is a more detailed block diagram illustrating the transaction card management server 110 of the system 100 of FIG. 1, according to some embodiments. The transaction card management server 110 includes a user account module 210, an instant app generation engine 220, an instant app management module 230, a transaction card validation module 240, and a network communication module 250. The components can be implemented in hardware, software, or a combination. The use account module 210 provides user interfaces to receive input from users seeking control over transaction cards. A dashboard can provide web purchases or reloading of gift cards. The dashboard also shows a status for each transaction card, such as whether a user has opened a customized instant app at a receiver device, and whether the transaction card has been transferred to an online digital wallet or other entity.

The instant app generation engine 220 customizes app templates according to various factors, for example, sender data, receiver data, and transaction data. Another example customizes by vendor or by financial institution. Source code is generated based factors. For example, code can be modified based on whether a receiver device is a smartphone or a laptop, and also based on whether its operating system is iOS or Android. Code for a gift card can be different from code for a debit card. In one implementation, code templates are submitted by vendors for distribution in order to control branding uniformity and streamlining. For example, a PayPal user interface can take a payment from a customer, send a customized instant app to a vendor with single button acceptance into the vendor's PayPal account. Security is satisfied without user input or burden. In other examples, a user can be presented with a list of digital wallets to choose from. APIs for the selected digital wallet automatically authenticate the user and transfer a transaction card.

The instant app management module 230 distributes and tracks instant apps after distribution, in an embodiment. Customized instant apps can be distributed over SMS text message, for example. E-mails, instant messages, and advertisements (e.g., an ad with a QR-code), are other examples. Users can activate instant apps by clicking a downloaded image, scanning the QR-code, replying with approval to download, or the like. Instant apps can also be automatically initiated by other apps, by time activation, or responsive to a mobile device event. Once instant apps are temporarily installed, user interactions and other data are captured and sent back to the instant app management module 230 over a secure connection. In some cases, a reply with specifically requested data is sent back to the temporary installation from the instant app management module 230, for instance, back and forth messages from scheduling an appointment. The instant app module 230 can track how long instant apps are kept active at receiver devices and notify in real-time when instant apps are deactivated.

The transaction card validation module 240 responds to online data wallets requesting to validate transaction cards prior to committing the transfer. Various security features can be implemented, such as one time passwords (OTPs), security keys, secret passwords, unique card numbers, biometrics, and the like. When a first user transfers a card to a mobile device of the same first user, automatic and transparent validation processes of the mobile device take place. One embodiment recognizes attempts to hack and invalidates an underlying instant app and transaction card.

The network communication module 250 can include a network interface, transceivers, antenna, protocol software, operating systems, APIs and other necessary components.

FIG. 3A is an example sequence diagram illustrating interactions between the components of the system of FIG. 1 for an iOS-based mobile device with screenshots, according to an embodiment. Variations in the sequence are possible.

At interaction 301,311 a transaction card management server sends an instant app with the transaction card to a receiver device. An optional SMS text service can proxy for download requests (e.g., Twilio SMS), at interaction 302.

At interaction 303, the instant app in the form of App Clips is downloaded from, for example, the Apple Store. The instant app in the form of Instant App is downloaded from the Google Play Store, at interaction 313 of FIG. 3B. A vendor can upload private customized instant apps for an individual user.

At interaction 304,314 the transaction card is transferred from the receiver device to the online digital wallet. In some embodiments, additional interactions validate the transaction card.

At interaction 305,315 a confirmation is sent from the online digital wallet to the receiver device that the transaction card has been successfully transferred and added to the online digital wallet.

FIG. 3B is a sequence diagram illustrating interactions between components of the system of FIG. 1 for an Android-based device with screenshots, according to an embodiment. One main difference between the embodiments of FIG. 3A and FIG. 3B is that Android-based mobile devices download from an SMS link rather than being pre-downloaded as in the iOS-based devices. These are just examples, as an Android-based device can be modified by one of ordinary skill in the art to pre-download instant apps.

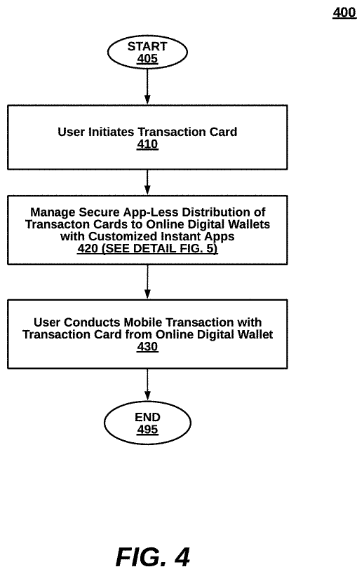

### II. Methods for App-Less Distribution of Customized Transaction Cards (FIGS. 4-6)

FIG. 4 is a flow diagram illustrating a method of managing secure app-less distribution of customized transaction cards to online digital wallets with customized instant apps, according to an embodiment.

At step 410, a user initiates the process by submitting for a transaction card. When a user opens a new account, a transaction card can be requested, for example.

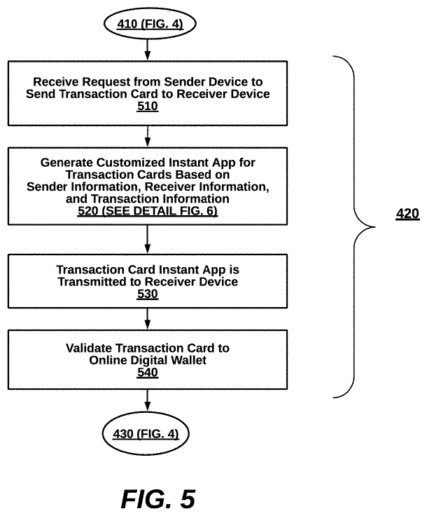

At step 420, a transaction card management server transfers transaction cards through customized instant apps, as disclosed more fully in FIG. 5. In some cases, the card is transferred to the user's wallet and in other cases transferred to a receiver user's wallet.

At step 430, a mobile transaction is conducted by user with transaction card from online digital wallet. Transactions can be completed using NFR, QR-codes or other wireless or tap mechanisms for in-person transactions. Remote purchases online can also be consummated with transaction cards. The transactions can be completed by a user that initiated the transaction card at step 410, or by a receiver or giftee of a card. Moreover, transaction details about transfer of the transaction card can be reported to the user or vendor. The vendor can debit the user account based on a confirmed “cashing in” transaction cards.

FIG. 5 is a more detailed flow diagram illustrating a step of generating the customized instant app from the method 400 of FIG. 4, according to an embodiment.

At step 510, a request is received from a sender device to send a transaction card to a receiver device.

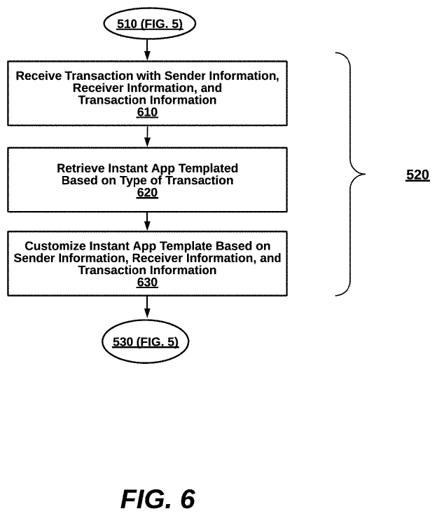

At step 520, a customized instant app for the transaction card based on at least sender information, receiver information, and transaction information is generated. The instant app is executed by an operating system without previous installation by the operating system. More detail for the instant app customization step 520 is shown in FIG. 6.

More specifically, at step 610, a transaction is received with sender information, receiver information, and transaction information. At step 620, an instant app template is retrieved based on the type of transaction. At step 630, the instant app template is customized based on at least the sender information, receiver information, and transaction information. In one embodiment, the instant apps are generated automatically in response to a transaction initiated by the sender. In some embodiments herein, the sender is sending to themselves as the receiver.

Referring again to FIG. 5, at step 530, the transaction card instant app is transmitted to the receiver device either directly or indirectly via Google Play Store or Apple Store, or the like. Instant apps can be completely unique and generated on-the-fly for a user, or a prefab instant app is referred for download, based on vendor, type of transaction card, type of asset, and other factors. The receiver device executes the transaction card instant app in order to transfer the transaction card to an online digital wallet.

At step 540, a request to validate the transaction card from the online wallet is received. Responsive to validating the transaction card, at step 650, an approval response is sent. The online digital wallet confirms the transfer of the transaction card. Optionally, the transaction card is deactivated at the transaction card management server.

### III. Processor-Driven Computing Device (FIG. 7)

FIG. 7 is a block diagram illustrating an exemplary computing device 700 for use in the system 100 of FIG. 1, according to one embodiment. The computing device 700 is an exemplary device that is implementable for the card transaction management server 110, the online digital wallet 120, the sender device 130, and the receiver device 140. Additionally, the computing device 700 is merely an example implementation itself, since the system 100 can also be fully or partially implemented with laptop computers, tablet computers, smart cell phones, Internet appliances, and the like.

The computing device 700, of the present embodiment, includes a memory 710, a processor 720, a storage drive 730, and an I/O port 740. Each of the components is coupled for electronic communication via a bus 799. Communication can be digital and/or analog and use any suitable protocol.

The memory 710 further comprises network applications 712 and an operating system 714. The network applications 712 can include a web browser, a mobile application, an application that uses networking, a remote application executing locally, a network protocol application, a network management application, a network routing application, or the like.

The operating system 714 can be one of the Microsoft Windows®. family of operating systems (e.g., Windows 95, 98, Me, Windows NT, Windows 2000, Windows XP, Windows XP x84 Edition, Windows Vista, Windows CE, Windows Mobile, Windows 7, Windows 8, and Windows 8), Android, Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 720 can be a network processor (e.g., optimized for IEEE 802.11), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory or the storage device 730.

The storage device 730 can be any non-volatile type of storage such as a magnetic disc, EEPROM, Flash, or the like. The storage device 730 stores code and data for applications.

The I/O port 740 further comprises a user interface 742 and a network interface 744. The account holder interface 742 can output to a display device and receive input from, for example, a keyboard. The network interface 744 connects to a medium such as Ethernet or Wi-Fi for data input and output. In one embodiment, the network interface 744 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use.

We claim:

1. A computer-implemented method in a transaction card management server, on a data communication network and at least partially implemented in hardware, for managing secure app-less distribution of customized transaction cards to online digital wallets with instant apps, the method comprising:
receiving a transmission, at a network communication interface of the transaction card server coupled to the data communication network, of data packets comprising a request from a sender device to send a transaction card to a receiver device;
generating, by a processor of the transaction card server, a customized instant app for the transaction card based on at least sender information, receiver information, and transaction information, wherein the instant app is executed by an operating system without previous installation by the operating system;
sending, by the network communication interface, the transaction card instant app to the receiver device, wherein the receiver device executes the transaction card instant app in order to transfer the transaction card to an online digital wallet;
receiving, at the network communication interface, a request to validate the transaction card from the online wallet; and
responsive to validating the transaction card, sending an approval response, at the network communication interface, wherein the online digital wallet confirms the transfer of the transaction card, and deactivating the transaction card at the transaction card management server.

2. The method in the transaction card management server of claim 1, wherein sending the transaction card instant app comprises:
sending an SMS via text message with a hyperlink to the transaction card app; and
responsive to receiving a hyperlink click, sending the transaction card instant app.

3. The method in the transaction card management server of claim 1, wherein generating the instant app comprises:
receiving the transaction information comprising an amount approved for the transaction from a merchant;
retrieving an app template based on a type of transaction;
modifying the app template to reflect the transaction amount.

4. The method in the transaction card management server of claim 1, wherein the receiver device comprises one of an iOS-based device and an Android-based device.

5. A non-transitory computer-readable medium comprising source code that, when executed by a processor, performs a computer-implemented method in a transaction card management server, on a data communication network and at least partially implemented in hardware, for managing secure app-less distribution of customized transaction cards to online digital wallets with instant apps, the method comprising:
receiving a transmission, at a network communication interface of the transaction card server coupled to the data communication network, of data packets comprising a request from a sender device to send a transaction card to a receiver device;
generating, by a processor of the transaction card server, a customized instant app for the transaction card based on at least sender information, receiver information, and transaction information, wherein the instant app is executed by an operating system without previous installation by the operating system;
sending, by the network communication interface, the transaction card instant app to the receiver device, wherein the receiver device executes the transaction card instant app in order to transfer the transaction card to an online digital wallet;
receiving, at the network communication interface, a request to validate the transaction card from the online wallet; and
responsive to validating the transaction card, sending an approval response, at the network communication interface, wherein the online digital wallet confirms the transfer of the transaction card, and deactivating the transaction card at the transaction card management server.

6. A transaction card management server, on a data communication network and at least partially implemented in hardware, for managing secure app-less distribution of customized transaction cards to online digital wallets with instant apps, the transaction card management server comprising:
receiving a transmission, at a network communication interface of the transaction card server coupled to the data communication network, of data packets comprising a request from a sender device to send a transaction card to a receiver device;
generating, by a processor of the transaction card server, a customized instant app for the transaction card based on at least sender information, receiver information, and transaction information, wherein the instant app is executed by an operating system without previous installation by the operating system;
sending, by the network communication interface, the transaction card instant app to the receiver device, wherein the receiver device executes the transaction card instant app in order to transfer the transaction card to an online digital wallet;
receiving, at the network communication interface, a request to validate the transaction card from the online wallet; and
responsive to validating the transaction card, sending an approval response, at the network communication interface, wherein the online digital wallet confirms the transfer of the transaction card, and deactivating the transaction card at the transaction card management server.
